(19) United States
(12) Patent Application Publication
(10) Pub. No.: US 2004/0073411 A1
(43) Pub. Date: Apr. 15, 2004

(54) System, method and computer program product for maintaining a structure

(75) Inventors: Mark S. Alston, Seattle, WA (US); Everett A. Bud Westerman, Auburn, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company, Chicago, IL

(21) Appl. No.: 10/271,609

(22) Filed: Oct. 15, 2002

(51) Int. Cl. G06F 17/50

(52) U.S. Cl. 703/1

(57) ABSTRACT

A system is provided for maintaining a structure that includes a plurality of components, where the system includes a database and a processing element. The database can store a surface map of the structure that includes a three-dimensional actual model representative of the structure. The surface map includes a plurality of maintenance zones that each includes a three-dimensional actual model representative of at least one component. At least two of the maintenance zones include a three-dimensional actual model representative of a portion of the same component. The database can also store at least one maintenance action associated with each maintenance zone. The processing element can generate a maintenance plan for the structure based upon the maintenance zones and the maintenance actions associated with each maintenance zone. The processing element can also drive at least one maintenance device to perform at least one maintenance operation based upon the maintenance plan.

### FIELD OF THE INVENTION

The present invention relates to systems and methods for maintaining a structure such as an aircraft and, more particularly, relates to systems and methods of maintaining a structure utilizing a surface map of the structure to define a plurality of maintenance zones.

### BACKGROUND OF THE INVENTION

Typically, inspections and other outer-mold-line maintenance procedures currently planned for structures, such as aircraft, are based solely as a function of chronological time, visual inspection results and operation history of the structure. Such planning is generally accomplished in accordance with technical orders and other technical publications. Repairs and modifications to be performed, are typically only described in the maintenance records for the structure or noted on drawings of the structure. Using such conventional techniques for planning inspections and maintenance procedures, however, previous repairs are often forgotten or otherwise unable to be located during future maintenance actions. When replacement components or modifications are required, spares are manufactured to the original drawings or to whatever design data is available. But because of dimensional deformation that can occur in the structure over the life of the structure, replacement structural components rarely fit properly and often require significant modification during installation.

Once respective inspections and/or maintenance procedures have been planned, such procedures are often performed manually. In this regard, such inspections and maintenance procedures typically require excessive labor costs and structure downtime. With existing approaches to periodic inspections and maintenance, personnel are directed to the proper location of the structure by disposition, technical manuals and/or process specifications with applicable drawings as required. The personnel then locate the area on the structure visually and conduct the required procedure, generally based upon past experience and information found in the technical manuals.

Whereas conventional procedures for conducting periodic inspections and maintenance are adequate, such procedures have drawbacks. In this regard, no definitive method exists to insure that personnel will inspect or maintain the entire area of the structure in question or even the correct area of the structure. Also, many locations of the structure, particularly on larger structures, require the use of extensive work stands or other support equipment to enable personnel to access the location. The use of such work stands and other support equipment, however, often place personnel in undesirably dangerous positions.

In addition, whereas comparisons of historic inspection and maintenance data taken against recent inspection and maintenance data are typically desirable to properly maintain the structure, such comparisons cannot be easily accomplished. In this regard, historic inspection and maintenance data are often difficult to store and maintain, and thereafter recall for comparison with recent inspection and maintenance data. And in the unlikely event that historic data is available, the comparison between the historic data and recent data is often undesirably accomplished solely based upon the subjective judgment of an operator, such as a nondestructive inspection (NDI) technician. Overall, conventional methods for performing such inspection and maintenance procedures take considerable man-hours to complete, involve extensive support equipment and are potentially inconsistent from one procedure to the next.

### SUMMARY OF THE INVENTION

In light of the foregoing background, the present invention provides an improved system, method and computer program product for maintaining a structure, such as a vehicle, aircraft or rotorcraft. The system, method and computer program product of embodiments of the present invention associate maintenance requirements for components of the structure with electronic surface maps of the structure broken down into maintenance zones each including at least one component of the structure. Advantageously, by utilizing electronic surface maps of the structure, different maintenance zones can include different portions of the same component such that each portion can be associated with different maintenance requirements. Also, by associating maintenance requirements with the electronic surface maps and, more particularly, the maintenance zones, the system, method and computer program product of embodiments of the present invention are capable of driving maintenance devices, such as robotic systems, to perform maintenance operations based upon the electronic surface maps, maintenance zones and maintenance requirements. As such, the system, method and computer program product of embodiments of the present invention are capable of maintaining the structure with a higher degree of automation and procedure accuracy than conventional systems and methods.

According to one aspect of the present invention, a system is provided for maintaining a structure that includes a plurality of components. The system includes a database and a processing element. The database is capable of storing a surface map of the structure comprising a three-dimensional actual model representative of the structure. The surface map includes a plurality of maintenance zones that each include a three-dimensional actual model representative of at least one component of the structure. Advantageously, at least two of the maintenance zones include a three-dimensional actual model representative of a portion of the same component. The database is also capable of storing at least one maintenance action associated with each maintenance zone. The processing element, which is in electrical communication with the database, is capable of generating a maintenance plan for the structure based upon the maintenance zones and the maintenance actions associated with each maintenance zone. The processing element is also capable of driving at least one maintenance device to perform at least one maintenance operation based upon the maintenance plan.

The processing element can be capable of receiving maintenance data for at least one maintenance zone based upon the performance of the at least one maintenance operation by the at least one maintenance device. Based upon the maintenance data, then, the processing element can be capable of updating at least one of the maintenance actions and/or the maintenance zones to thereby update the maintenance plan.

The system can also include a metrology system capable of mapping a plurality of points of the structure. In this regard, the processing element can be capable of generating the surface map based upon the points. The system can also include the maintenance devices that are capable of performing the maintenance operations. In such embodiments, the maintenance devices can gather data as they perform the maintenance operations. The processing element can then generate maintenance data based upon the data gathered by the maintenance devices. From the maintenance data, then, the processing element can be capable of updating at least one maintenance action and/or the maintenance zones to thereby update the maintenance plan.

In addition to performing the maintenance operations and gathering data, the maintenance devices can be further capable of mapping a plurality of points of the structure after performing the maintenance operations. In such embodiments, the processing element can generate an updated surface map based upon the points, and the database can store the updated surface map. The processing element can then be capable of comparing the surface map and the updated surface map and thereafter generating maintenance data for at least one maintenance zone based upon the comparison. Based upon the maintenance data, then, the processing element can be capable of updating at least one maintenance action and/or the maintenance zones to thereby update the maintenance plan.

A method and computer program product for maintaining a structure are also provided.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system for maintaining a structure according to one embodiment of the present invention;

FIGS. 2A and 2B are schematic illustrations of presentations of a display highlighting a component of a structure and two associated maintenance zones, according to one embodiment of the present invention; and

FIG. 3 is a flow chart illustrating various steps in a method for maintaining a structure according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

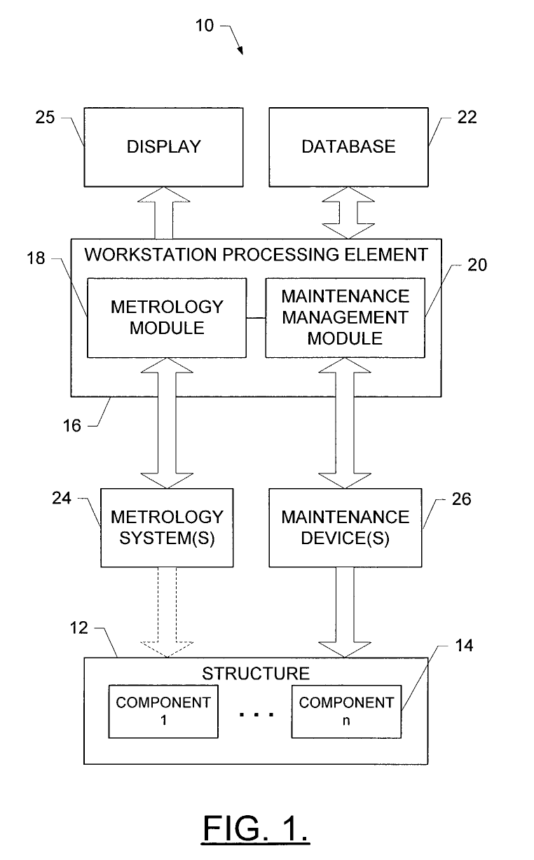

Referring to FIG. 1, a system 10 is provided for maintaining a structure 12 comprising a plurality of components 14. As illustrated and described herein, the structure comprises an aircraft. It should be understood, however, that the structure can comprise any of a number of structures that include a plurality of components, without departing from the spirit and scope of the present invention. For example, the structure can comprise a vehicle such as an automobile, or a machine such as a milling machine.

The system 10 includes a workstation processing element 16 that has a metrology module 18 and a maintenance management module 20. The workstation processing element can comprise any of a number of different devices, such as a personal computer, laptop computer or other high level processor, operating under control of a computer program product as described below. The workstation processing element is capable of planning and managing the maintenance of the structure 12, and can additionally drive maintenance devices 26 to perform maintenance operations on the structure, as described below. In this regard, the workstation processing element is in electrical communication with a database 22 that can store a number of different types of maintenance and inspection data related to the structure and, more particularly, components 14 of the structure. For example, the database can store “template” maintenance requirements for the model of aircraft, as such could be established by the Federal Aviation Administration (FAA) when the structure comprises an aircraft. In addition the database can store maintenance data, such as current and historical non-destructive inspection (NDI) data, specific to the structure, as well as maintenance instructions specific to the structure and criteria for modifying a maintenance plan for the structure, as described below.

Advantageously, the database 22 can also store a surface map of the structure 12 comprising a three-dimensional actual model representative of the structure. The database can receive the surface map in any one of a number of different manners. For example, the workstation processing element can receive the surface map from a nominal computer aided design (CAD) specification of the structure. Alternatively, in one advantageous embodiment, the workstation processing element 16 can drive one or more metrology systems 24 to map the structure or, more particularly, map a plurality of points of the components 14 of the structure. As will be appreciated by those skilled in the art, the metrology systems can comprise any of a number of different systems, including contact and non-contact measuring systems such as laser trackers, photogrammetric systems, conventional and portable coordinate measuring machines (CMM's), theodolites, scanners and total stations, devices providing weather station data, component temperature probes, data loggers, electronic calipers, micrometers, flush and trim gauges. For example, laser trackers, which are a contact measurement system, provide highly accurate static and dynamic linear displacement (distance) and angular (horizontal, vertical) measurements using a retroreflective target (spherically mounted Retroreflector (SMR)), which is held against the object to be measured, e.g., the structure. In operation, light reflects off the target to thereby retrace the path of the target and re-entering the tracker at the exact position it left. Another measuring system, a photogrammetric system, is a video-based system that utilizes high-resolution video cameras instead of film cameras.

From the points of the structure 14 mapped by the metrology systems 24, the workstation processing element 16 and, more particularly, the metrology module 18 of the workstation processing element, can generate the surface map of the structure, which can thereafter be stored in the database 22. While the metrology module can comprise any of a number of different hardware or firmware devices capable of generating the surface map, the metrology module is preferably a computer software program operating within the workstation processing element. For example, the metrology module can comprise the CATIA software package distributed by Dassault Systemes S.A. of Suresnes Cedex, France.

In addition to generating the surface map, the workstation processing element 16 can drive a display 25 to present, among other items, the surface map of the structure 12. The display can comprise any of a number of known devices, such as a monitor or the like. By driving the display to present the surface map and other displays in accordance with the present invention, the workstation processing element can facilitate operator input into operation of the system 10, and operator review of the surface map and data regarding the structure.

Advantageously, from the surface map of the structure 12, the workstation processing element 16, and, more particularly, the maintenance management module 22, can establish a plurality of maintenance zones, where each maintenance zone includes a three-dimensional actual model representative of at least one component 14 of the structure. For example, when the structure comprises an aircraft, the maintenance management module can establish maintenance zones comprising lap joints, skin/rib joints, wing spar/skin joints, critical skin panels, cargo doors and leading edge (LE) flaps. Like the metrology module 18, the maintenance management module can comprise any of a number of different hardware or firmware devices capable of generating the surface map. However, in one embodiment, the maintenance management module comprises a computer software program operating within the workstation processing element.

The maintenance zones are defined based upon the surface map and the maintenance and inspection data related to the structure 12 stored in the database 22. It will be appreciated that data specific to the structure, such as current and historical NDI data, can be utilized to alter maintenance requirements of a structure. As such, as described below, the workstation processing element 16 can not only establish the maintenance zones, but the workstation processing element can add, delete or otherwise modify the maintenance zones based upon the maintenance and inspection data related to the structure stored in the database.

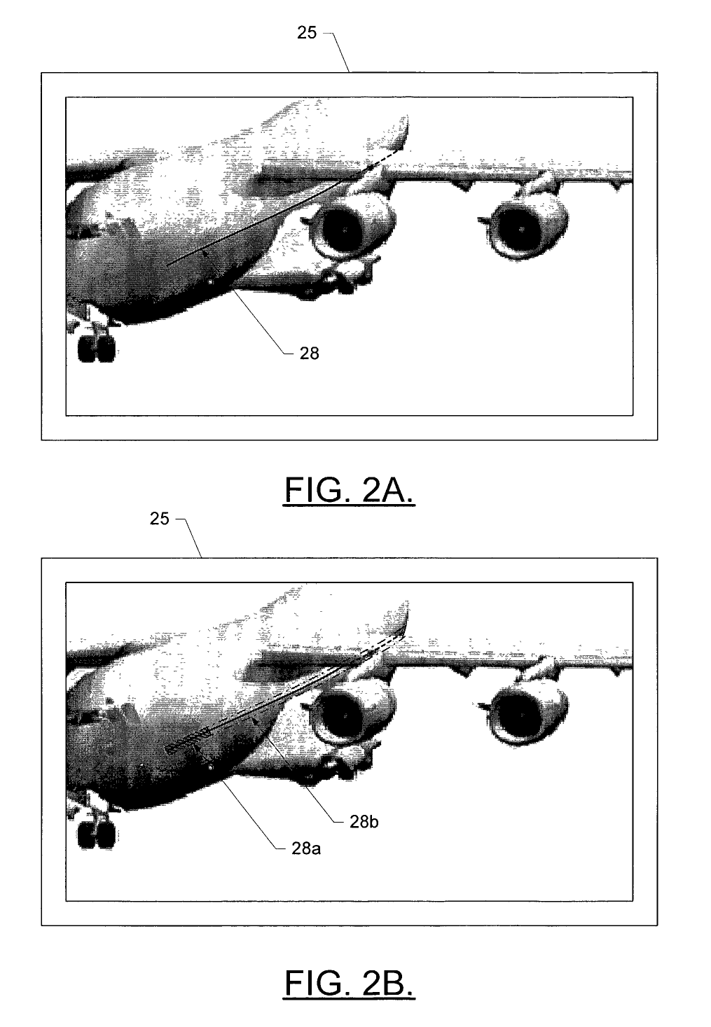

It will also be appreciated that although maintenance requirements for the structure 12 are typically established on a component-by-component level, such requirements can be inadequate or an inefficient utilization of maintenance resources. For example, presume the structure comprises an aircraft and one of the components 14 comprises a fuselage lap joint. In such an instance, a conventional maintenance requirement bases maintenance and inspection actions upon the entire fuselage lap joint 28, as shown in the display 25 presentation of FIG. 2A. Presume, however, that a first portion of the lap joint has historically been prone to crack around the rivets of the joint at a faster rate than a second, remaining portion of the lap joint. In such an instance, basing the periodic inspection of the lap joint on cracking around the rivets of the second portion would be inadequate because cracks historically affect the rivets on the first potion of the joint at a faster rate then the cracks affect the rivets on the second portion. Conversely, basing the periodic inspection on cracks affecting rivets of the first portion would utilize maintenance requirements in an inefficient manner because the second portion of the joint would be subjected to many unnecessary inspections.

To account for different maintenance requirements on a sub-component level, at least one component 14 of the structure 12 is broken up between two different maintenance zones including different maintenance actions for each portion of the component, as described below. More particularly, at least two maintenance zones include a three-dimensional actual model representative of portions of a component. For example, the surface map could include one maintenance zone comprising the first portion 28a of the fuselage lap joint, and another maintenance zone comprising the second portion 28b of the fuselage lap joint, as both are shown in FIG. 2B.

As stated, the workstation processing element 16 is capable of planning and managing the maintenance of the structure 12. In this regard, the workstation processing element can generate a maintenance plan for the structure 12 that is based upon the maintenance and inspection data related to the structure, and that includes maintenance actions for the maintenance zones. The maintenance actions can include any of a number of different inspections and other outer-mold-line maintenance procedures related to the structure and, more particularly, the maintenance zones. The maintenance actions can be planned in any one of a number of different manners, as such are known to those skilled in the art. According to conventional maintenance planning techniques where the structure comprises an aircraft, the maintenance actions can comprise periodic inspections of various components of the aircraft, such as inspecting the lap joints every 24 months and the spar/skin joints every 12 months.

In contrast to conventional maintenance planning techniques, however, the workstation processing element of embodiments of the present invention can plan maintenance actions for the structure based upon the established maintenance zones of the surface map of the structure. For example, a maintenance action can be planned to include inspecting the maintenance zone comprising the first portion of the fuselage lap joint for cracks around the rivets of the joint every six months, but inspecting the maintenance zone comprising the second portion on a larger interval.

Advantageously, the maintenance zones can be defined by a plurality of points and/or surfaces on the surface map to thereby plan maintenance actions based upon the maintenance zones. Thus, as stored in the database 22, a maintenance action of inspecting the first portion of the lap joint could include the following entry: Maintenance Zone: MZ04029A-01; Location: X1 to X2, Y1 to Y2, Z1 to Z2—Surface 1A, 1B; Inspections: Cracks (MOI)—6 Months, Corrosion (EC)—12 months. In such an entry, MZ04029A-01 is an identifier associated with the first portion of the lap joint; X1 to X2, Y1 to Y2, Z1 to Z2 - Surface 1A, 1B represents the location of the first portion of the lap joint; MOI represents Magneto-Optic Imaging inspection of the maintenance zone for cracks; and EC represents Eddy Current test inspection of the maintenance zone for corrosion.

In addition to planning the maintenance actions for the structure 12, the workstation processing element 16 can manage the maintenance plan for the structure. For example, the workstation processing element can receive maintenance data, such as NDI data, related to the maintenance zones as the maintenance actions are performed. The workstation processing element can thereafter store the maintenance data in the database 22 along with the other information stored related to the maintenance zones. For example, when the information in the database includes NDI data and the maintenance data includes NDI data, the workstation processing element can repeatedly store the received NDI data such that the database maintains historical NDI data related to the maintenance zones.

Utilizing the criteria for altering maintenance plan for the structure 12 and the current and historical NDI data stored in the database 22, then, the workstation processing element 16 can update the maintenance actions for the maintenance zones. Additionally, or alternatively, the workstation processing element can add, delete or otherwise modify the maintenance zones based upon the criteria for altering the maintenance plan for the structure 12 and the current and historical NDI data. For example, presume the workstation processing element originally established a maintenance zone to include the entire fuselage lap joint 28, and a criteria for altering maintenance actions relative to the lap joint includes altering the frequency of inspections if cracks around rivets of the joint affect less than three percent of the rivets or more than six percent of the rivets in a period of two inspections. Also presume that current and historical NDI data shows that the first portion 28a of the lap joint has exhibited cracks affecting seven percent of the rivets in two consecutive inspections, but the second portion 28b exhibited cracks affecting only one percent of the rivets in the same time period. In such an instance, the workstation processing element can divide the lap joint into two maintenance zones comprising the first and second portions of the lap joint respectively. The workstation processing element can continue by planning a maintenance action for the first portion to be inspected more often than the entire lap joint was previously inspected, and for the second portion to be inspected less often than the entire lap joint was previously inspected.

In addition to planning and managing maintenance actions of the structure 12, the workstation processing element 16 can also drive at least one maintenance device 26 to perform at least one maintenance operation based upon maintenance actions from the maintenance plan. Advantageously, by associating the maintenance and inspection data related to the structure with a maintenance zone comprising a three-dimensional representation of a portion of the structure, the workstation processing element 16 can drive the maintenance devices to the location on the structure to perform the maintenance operation based upon the maintenance zone. As such, maintenance of the structure can be automated, such as by robotic maintenance devices.

To facilitate the workstation processing element 16 managing the maintenance plan for the structure 12, the maintenance devices 26 can be capable of gathering data as the maintenance devices perform the maintenance operations. For example, to facilitate the workstation processing element in subsequently updating the surface map and/or maintenance zones, the maintenance devices can also be capable of mapping the structure, particularly the maintenance zone(s) upon which the maintenance devices perform the maintenance operations. Also, for example, the maintenance devices can be capable of gathering data, such as NDI data, that the workstation processing element can subsequently use to update maintenance actions and/or maintenance zones. The maintenance devices can comprise any of a number of different devices capable of performing maintenance operations on the structure.

For example, when the structure comprises an aircraft, one maintenance device can comprise a surface crawling robotic device capable of inspecting at least a portion of the aircraft. Such surface crawling robotic devices are well known to those skilled in the art.

Also, for example, the workstation processing element 16 can drive the maintenance devices 26 to map the structure 12 or, more particularly, map a plurality of points of the maintenance zones either during or after the maintenance devices perform the maintenance operations on such maintenance zones. In this regard, various ones of the maintenance devices can include various ones of the metrology systems 24. The workstation processing element can then generate an updated surface map of the structure based upon the points mapped by the maintenance devices. The workstation processing element can then compare the surface map of the structure stored in the database 22 with the updated surface map, such as by utilizing a known image recognition-based software package, such as CATIA. For example, software packages such as CATIA can be configured to identify several markers on the updated surface map, associate those markers with corresponding points on the surface map stored in the database, and thereafter modify the surface map stored in the database to fit the updated surface map.

In addition to, or in lieu of, comparing the surface map stored in the database with the updated surface map, the workstation processing element can correlate the gathered NDI data with the surface map stored in the database, such as by utilizing any of a number of known software packages, such as the EnCapta software package distributed by Vistagy, Inc. of Waltham, Massachusetts.

However the comparison is accomplished, after performing the comparison, the workstation processing element 16 can generate further maintenance data, such as NDI data, from which the workstation processing element can update the maintenance zones and/or maintenance actions. Additionally, the workstation processing element can identify structural changes to the structure 12 and updated the maintenance zones and/or maintenance actions accordingly.

In addition, the workstation processing element 16 can replace the surface map, or portions thereof, with the updated surface map. It will be appreciated that by replacing the surface map with the updated surface map, degradation and other alterations in the structure 12 can be monitored over the life time of the structure. The degradations and other alterations can then be utilized by the workstation processing element such that subsequent actions performed by the workstation processing element, such as driving the maintenance devices, are based upon a more current three-dimensional representation of the structure. In addition, or in the alternative, the degradations and other alterations can be utilized in customizing repairs and modifications for the structure based upon the actual structure as opposed to a nominal specification of the structure, as is currently utilized.

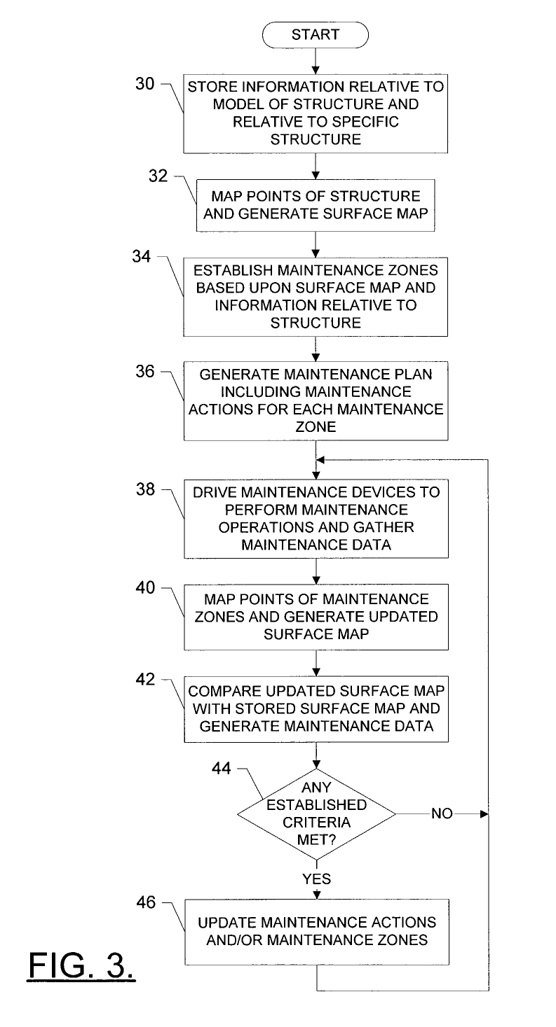

Reference is now drawn to FIG. 3, which illustrates a method of operating the system 10 according to one exemplar embodiment of the present invention. The method begins by storing maintenance and inspection data relative to the structure 12, as shown in block 30. For example, the database can store “template” maintenance requirements for the model of aircraft, as such could be established by the Federal Aviation Administration (FAA) when the structure comprises an aircraft. In addition the database can store maintenance data, such as current and historical non-destructive inspection (NDI) data, specific to the structure, as well as maintenance instructions specific to the structure and criteria for modifying a maintenance plan for the structure.

After storing the maintenance and inspection data, a plurality of points of the structure 12 are mapped, such as by the metrology systems 24, as shown in block 32. Then, from the mapped points, a surface map of the structure 12 is generated. And from the surface map and the maintenance and inspection data, maintenance zones are established, as illustrated in block 34. More particularly, when the structure comprises an aircraft, the maintenance zones can be established based upon the “template” maintenance requirements, current and historical NDI data, and/or maintenance instructions specific to the structure. As described above, the maintenance zones can be established to include one or more components. As also described above in conjunction with the example of the fuselage lap joint, however, at least two maintenance zones may include portions of at least one component 14. In other terms, at least one component can be divided among more than one maintenance zone.

After the maintenance zones have been established for the structure 12, a maintenance plan for the structure can be generated that includes at least one maintenance action for each maintenance zone, as shown in block 36. The maintenance plan is preferably generated based upon the maintenance and inspection data related to the structure. As illustrated in block 38, after the maintenance plan has been generated, at least one maintenance device 26 can be driven to perform maintenance operations based upon the maintenance plan. As the maintenance devices perform the maintenance operations, the maintenance devices can gather maintenance data, such as NDI data, for the structure.

As shown in block 40, either as the maintenance devices 26 perform the maintenance operations, or after the maintenance operations have been performed, a plurality of points of the structure can be mapped. More particularly, the maintenance zones upon which the operations were performed can be mapped. With the mapped maintenance zones, then, an updated surface map can be generated. The updated surface map is then compared to the surface map of the structure 12, and maintenance data, such as NDI data, can be generated based upon the comparison, as shown in block 42. After comparing the surface map to the updated surface map, the surface map can be replaced with the updated surface map such that the surface map most accurately represents the structure and will be used in subsequent maintenance procedures.

Then, utilizing the maintenance data gathered by the maintenance devices, the maintenance data generated based upon the comparison of the surface maps, and the inspection and maintenance data related to the structure, a determination can be made whether the maintenance actions and/or the maintenance zones should be updated. In this regard, in embodiments where the inspection and maintenance data includes criteria for updating the maintenance plan, the criteria can be checked to see if any of the criteria have been met, as shown in block 44. If any of the criteria have been met, the respective maintenance actions and/or maintenance zones are updated, such as by adding, deleting and/or modifying maintenance actions and/or maintenance zones, as illustrated in block 46. After updating the maintenance actions and/or maintenance zones, or if necessary, the method can be repeated according to the predefined maintenance plan stored in the database 22, beginning with driving the maintenance devices to perform the maintenance actions on the structure.

Therefore, the present invention provides a system, method and computer program product for maintaining a structure, such as a vehicle, aircraft or rotorcraft. The system, method and computer program product of embodiments of the present invention associate maintenance requirements for components of the structure with electronic surface maps of the structure broken down into maintenance zones each including at least one component of the structure, with at least two maintenance zones including different portions of the same component. Also, by associating maintenance requirements with the maintenance zones, the system, method and computer program product of embodiments of the present invention are capable of driving the maintenance devices to perform maintenance operations based upon the electronic surface maps, maintenance zones and maintenance requirements. As such, the system, method and computer program product of embodiments of the present invention are capable of maintaining the structure with a higher degree of automation and procedure accuracy than conventional systems and methods.

In various advantageous embodiments, portions of the system and method of the present invention include a computer program product. The computer program product includes a computer-readable storage medium, such as the non-volatile storage medium, and computer-readable program code portions, such as a series of computer instructions, embodied in the computer-readable storage medium. Typically, the computer program comprises the metrology module 18 and the maintenance management module 20, and is stored and executed by a processing unit or a related memory device, such as the workstation processing element 16 as depicted in FIG. 1.

In this regard, FIGS. 1 and 3 are block diagram, flowchart and control flow illustrations of methods, systems and program products according to the invention. It will be understood that each block or step of the block diagram, flowchart and control flow illustrations, and combinations of blocks in the block diagram, flowchart and control flow illustrations, can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for maintaining a structure comprising a plurality of components, said system comprising:
a database capable of storing a surface map of the structure comprising a three-dimensional actual model representative of the structure, wherein the surface map includes a plurality of maintenance zones that each include a three-dimensional actual model representative of at least one component of the structure, wherein at least two maintenance zones include a three-dimensional actual model representative of a portion of the same component, and wherein the database is also capable of storing at least one maintenance action associated with each maintenance zone; and
a processing element in electrical communication with said database capable of generating a maintenance plan for the structure based upon the maintenance zones and the at least one maintenance action associated with each maintenance zone.

2. A system according to claim 1 further comprising a metrology system capable of mapping a plurality of points of the structure, wherein said processing element is capable of generating the surface map based upon the points.

3. A system according to claim 1, wherein said processing element is further capable of driving at least one maintenance device to perform at least one maintenance operation based upon the maintenance plan

4. A system according to claim 3, wherein said processing element is capable of receiving maintenance data for at least one maintenance zone based upon the performance of the at least one maintenance operation by the at least one maintenance device.

5. A system according to claim 4, wherein said processing element is capable of updating at least one of the at least one maintenance action and the maintenance zones based upon the maintenance data to thereby update the maintenance plan.

6. A system according to claim 1 further comprising at least one maintenance device capable of performing the at least one maintenance operation and gathering data as the at least one maintenance device performs the at least one maintenance operation.

7. A system according to claim 6, wherein said processing element is capable of generating maintenance data based upon the data gathered by the at least one maintenance device.

8. A system according to claim 7, wherein said processing element is capable of updating at least one of the at least one maintenance action and the maintenance zones based upon the maintenance data to thereby update the maintenance plan.

9. A system according to claim 6, wherein the at least one maintenance device is further capable of mapping a plurality of points of the structure after performing the at least one maintenance operation, wherein said processing element is capable of generating an updated surface map based upon the points, and wherein said database is capable of storing the updated surface map.

10. A system according to claim 9, wherein said processing element is capable of comparing the surface map and the updated surface map and thereafter generating maintenance data for at least one maintenance zone based upon the comparison.

11. A system according to claim 10, wherein said processing element is capable of updating at least one of the at least one maintenance action and the maintenance zones based upon the maintenance data to thereby update the maintenance plan.

12. A method for maintaining a structure comprising a plurality of components, said method comprising:
providing a surface map of the structure comprising a three-dimensional actual model representative of the structure, wherein the surface map includes a plurality of maintenance zones that each include a three-dimensional actual model representative of at least one component of the structure, wherein at least two maintenance zones include a three-dimensional actual model representative of a portion of the same component, and wherein the database is also capable of storing at least one maintenance action associated with each maintenance zone; and
generating a maintenance plan for the structure based upon the maintenance zones and the at least one maintenance action associated with each maintenance zone.

13. A method according to claim 12 further comprising mapping a plurality of points of the structure and thereafter generating the surface map based upon the points, wherein mapping the plurality of points occurs before providing the surface map.

14. A method according to claim 12 further comprising driving at least one maintenance device to perform at least one maintenance operation based upon the maintenance plan.

15. A method according to claim 14 further comprising receiving maintenance data for at least one maintenance zone based upon the performance of the at least one maintenance operation by the at least one maintenance device.

16. A method according to claim 15 further comprising updating at least one of the at least one maintenance action and the maintenance zones based upon the maintenance data to thereby update the maintenance plan.

17. A method according to claim 14 further comprising gathering data as the at least one maintenance device is driven to perform the at least one maintenance operation.

18. A method according to claim 17, wherein gathering data further comprises generating maintenance data based upon the data gathered by the at least one maintenance device.

19. A method according to claim 18 further comprising updating at least one of the at least one maintenance action and the maintenance zones based upon the generated maintenance data to thereby update the maintenance plan.

20. A method according to claim 17, wherein driving the at least one maintenance device further comprises driving the at least one maintenance device to map a plurality of points of the structure after performing the at least one maintenance operation, wherein said method further comprises generating an updated surface map based upon the points.

21. A method according to claim 20 further comprising comparing the surface map and the updated surface map and thereafter generating maintenance data for at least one maintenance zone based upon the comparison.

22. A method according to claim 21 further comprising updating at least one of the at least one maintenance action and the maintenance zones based upon the generated maintenance data to thereby update the maintenance plan.

23. A computer program product for maintaining a structure comprising a plurality of components, the computer program product comprising a computer-readable storage medium having computer-readable program code embodied in said medium, the computer-readable program code comprising:
a first executable portion for accessing a surface map of the structure comprising a three-dimensional actual model representative of the structure, wherein the surface map includes a plurality of maintenance zones that each include a three-dimensional actual model representative of at least one component of the structure, wherein at least two maintenance zones include a three-dimensional actual model representative of a portion of the same component, and wherein said first executable portion is also capable of accessing at least one maintenance action associated with each maintenance zone; and
a second executable portion for generating a maintenance plan for the structure based upon the maintenance zones and the at least one maintenance action associated with each maintenance zone.

24. A computer program product according to claim 23 further comprising a third executable portion for generating the surface map based upon a mapping of a plurality of points of the structure.

25. A computer program product according to claim 23 further comprising a third executable portion for driving at least one maintenance device to perform at least one maintenance operation based upon the maintenance plan.

26. A computer program product according to claim 25 further comprising a fourth executable portion for receiving maintenance data for at least one maintenance zone based upon the performance of the at least one maintenance operation by the at least one maintenance device.

27. A computer program product according to claim 26, wherein said second executable portion is further capable of updating at least one of the at least one maintenance action and the maintenance zones based upon the maintenance data to thereby update the maintenance plan.

28. A computer program product according to claim 25 further a fourth executable portion for receiving data gathered as the at least one maintenance device is driven to perform the at least one maintenance operation.

29. A computer program product according to claim 28, wherein said fourth executable portion is further capable of generating maintenance data based upon the data received.

30. A computer program product according to claim 29, wherein said fourth executable portion is further capable of updating at least one of the at least one maintenance action and the maintenance zones based upon the generated maintenance data to thereby update the maintenance plan.

31. A computer program product according to claim 28, wherein said third executable portion further drives the at least one maintenance device to map a plurality of points of the structure after performing the at least one maintenance operation, wherein said computer program product further comprises a fifth executable portion for generating an updated surface map based upon the points.

32. A computer program product according to claim 31, wherein said fifth executable portion is further capable of comparing the surface map and the updated surface map and thereafter generating maintenance data for at least one maintenance zone based upon the comparison.

33. A computer program product according to claim 32, wherein said fifth executable portion is further capable of updating at least one of the at least one maintenance action and the maintenance zones based upon the generated maintenance data to thereby update the maintenance plan.
